(19) United States
(12) Patent Application Publication
(10) Pub. No.: US 2024/0135165 A1
(43) Pub. Date: Apr. 25, 2024

(54) SYSTEMS AND METHODS FOR DATA CORRECTION

(71) Applicant: ADOBE INC., SAN JOSE, CA (US)

(72) Inventors: Varun Manjunatha, Newton, MA (US); Sarthak Jain, Boston, MA (US); Rajiv Bhawanji Jain, Falls Church, VA (US); Ani Nenkova Nenkova, Philadelphia, PA (US); Christopher Alan Tensmeyer, Fulton, MD (US); Franck Dernoncourt, Seattle, WA (US); Quan Hung Tran, San Jose, CA (US); Ruchi Deshpande, Belmont, CA (US)

(21) Appl. No.: 18/047,335

(22) Filed: Oct. 18, 2022

(51) Int. Cl. G06N 3/08; G06F 40/295

(52) U.S. Cl. CPC G06N 3/08; G06F 40/295

(57) ABSTRACT

One aspect of systems and methods for data correction includes identifying a false label from among predicted labels corresponding to different parts of an input sample, wherein the predicted labels are generated by a neural network trained based on a training set comprising training samples and training labels corresponding to parts of the training samples; computing an influence of each of the training labels on the false label by approximating a change in a conditional loss for the neural network corresponding to each of the training labels; identifying a part of a training sample of the training samples and a corresponding source label from among the training labels based on the computed influence; and modifying the training set based on the identified part of the training sample and the corresponding source label to obtain a corrected training set.

### BACKGROUND

The following relates to data correction. Machine learning models find ubiquitous applications in various software systems today. Generally, a supervised machine learning model is first trained on human-labeled input-output pairs, which comprise a training dataset. The performance of the machine learning model can then be verified on a validation dataset that includes ground truth information. If the performance of the machine learning model is satisfactory, then the machine learning model is suitable to be deployed for real-world tasks.

A principled approach towards identifying a cause of an erroneous prediction of a machine learning model on a validation dataset is a critical task in developing a machine learning model that features increased predictive accuracy on an unobserved test dataset. Conventional techniques for increasing a machine learning model's predictive accuracy typically involve re-annotating data, iterating over hyperparameters, architectures, and diagnosing errors using one of several heuristic methods. However, identifying and correcting erroneous training data is a laborious and time-consuming task. There is therefore a need in the art for data correction techniques that allow influential erroneous training data to be quickly identified and corrected.

### SUMMARY

Embodiments of the present disclosure provide systems and methods for data correction that allow for error tracing in a training dataset at an intra-sample and sub-sample level. Error tracing at an intra-sample and sub-sample level is especially useful for various complex machine learning tasks, where a single training sample in the training dataset can include multiple annotations. Examples of such complex machine learning tasks include object detection, in which a single image can include several instances of objects, and named entity recognition, in which a single text phrase can include multiple named entities.

Accordingly, aspects of the present disclosure identify a part of a training sample and a corresponding source label that has caused a neural network to predict an incorrect label for a part of a validation sample. In some cases, aspects of the present disclosure identify the causal relation between the part of a training sample, the corresponding source label, and the incorrect label by computing an influence of each of a plurality of training labels on the incorrect label by approximating a change in a conditional loss for the neural network corresponding to each of the plurality of training labels.

According to some aspects, aspects of the present disclosure provide a user interface that allows a user to provide a corrected label corresponding to a part of a training sample that has influenced the neural network to predict the incorrect label. According to some aspects, the system then corrects the training set using the corrected label to obtain a corrected training set. In some cases, the corrected training set can be used in downstream applications, such as re-training the neural network to increase the predictive accuracy of the neural network.

A method, apparatus, non-transitory computer readable medium, and system for systems and methods for data correction are described. One or more aspects of the method, apparatus, non-transitory computer readable medium, and system include identifying a false label from among a plurality of predicted labels corresponding to different parts of an input sample, wherein the plurality of predicted labels is generated by a neural network trained based on a training set comprising a plurality of training samples and a plurality of training labels corresponding to parts of the plurality of training samples; computing an influence of each of the plurality of training labels on the false label by approximating a change in a conditional loss for the neural network corresponding to each of the plurality of training labels; identifying a part of a training sample of the plurality of training samples and a corresponding source label from among the plurality of training labels based on the computed influence; and modifying the training set based on the identified part of the training sample and the corresponding source label to obtain a corrected training set.

A method, apparatus, non-transitory computer readable medium, and system for systems and methods for data correction are described. One or more aspects of the method, apparatus, non-transitory computer readable medium, and system include training a neural network to generate a plurality of labels corresponding to different parts of an input sample, respectively, wherein the neural network is trained based on a training set comprising a plurality of training samples and a plurality of training labels corresponding to parts of the plurality of training samples; identifying a false label from among the plurality of labels generated by the neural network; computing an influence of each of the plurality of training labels on the false label by approximating a change in a conditional loss for the neural network corresponding to each of the plurality of training labels; correcting a source label corresponding to a part of a training sample from the plurality of training samples based on the computed influence to obtain a corrected training set; and retraining the neural network based on the corrected training set.

An apparatus and system for systems and methods for data correction are described. One or more aspects of the apparatus and system include a processor; a memory including instructions executable by the processor; a neural network trained to generate labels corresponding to different parts of an input; and an influence component configured to compute an influence of each of a plurality of training labels on a target label by approximating a change in a conditional loss for the neural network corresponding to each of the plurality of training labels.

### BRIEF DESCRIPTION OF THE DRAWINGS

FIG. 1 shows an example of a data correction system according to aspects of the present disclosure.

FIG. 2 shows an example of a data correction apparatus according to aspects of the present disclosure.

FIG. 3 shows an example of data flow in a data correction system according to aspects of the present disclosure.

FIG. 4 shows an example of a user interface according to aspects of the present disclosure.

FIG. 5 shows an example of data correction according to aspects of the present disclosure.

FIG. 6 shows an example of training set modification according to aspects of the present disclosure.

FIG. 7 shows an example of identifying an influential text sample according to aspects of the present disclosure.

FIG. 8 shows an example of false label identification according to aspects of the present disclosure.

FIG. 9 shows an example of conditional loss approximation according to aspects of the present disclosure.

FIG. 10 shows an example of neural network retraining according to aspects of the present disclosure.

### DETAILED DESCRIPTION

The present disclosure relates to data correction. Machine learning models find ubiquitous applications in various software systems today. Generally, a supervised machine learning model is first trained on human-labeled input-output pairs, which comprise a training dataset. The performance of the machine learning model can then be verified on a validation dataset that includes ground truth information. If the performance of the machine learning model is satisfactory, then the machine learning model is suitable to be deployed ford real-world tasks.

A principled approach towards identifying a cause of an erroneous prediction of a machine learning model on a validation dataset is a critical task in developing a machine learning model that features increased predictive accuracy on an unobserved test dataset. Conventional techniques for increasing a machine learning model's predictive accuracy typically involve re-annotating data, iterating over hyperparameters, architectures, and diagnosing errors using one of several heuristic methods.

However, identifying and correcting erroneous training data is a laborious and time-consuming task. For example, collecting human-labeled data is not only an expensive and lengthy process, but there are no guarantees that the labels annotated by the human are correct. Furthermore, the task of collecting labels for a set of unlabeled data is complicated by the inherent complexity of the task itself (for example, classification typically requires one label per training sample, whereas object detection or entity-recognition require multiple labels per sample), ambiguities inherent to the training data (for example, in the case of entity recognition, it is not clear whether “England” in the sentence “England lost 2-0 to Italy in the Euro quarter-finals” refers to a location (the country of England) or an organization (implicitly, the England football team)), changing annotation guidelines through the evolution of a project, and mistakes made by human labelers, due to in-attention, misclicks, misunderstanding instructions, etc.

The stochastic nature of the process of training a machine learning model, coupled with a high dimensionality of the parameter space of the machine learning model, makes the process of iteratively increasing a predictive accuracy of the machine learning model an inexact science. Some conventional data correction techniques attempt to identify a cause for a machine learning model's prediction, where the cause can then be analyzed by a model developer and rectified in subsequent iterations or trainings of the machine learning model. For a fixed machine learning model architecture and hyperparameters, the machine learning model's performance (both correct and incorrect predictions) is a function of the data it is trained on, and removing one or more training points from the training dataset is likely to change the performance of the model.

Proceeding from this idea, a conventional data correction technique attempts to provide an approximation of a change in a validation loss for a validation datapoint if a particular training point is removed from the training dataset, but the technique is limited as it attempts to attribute a particular prediction to one or more training samples, but not to the annotations within the training sample. As the technique does not attribute a causal influence to annotations within the training sample (i.e., at a sub-sample level), the technique hinders a process of improving the machine learning model by requiring that the amount of data to be corrected includes an entire sample.

Some embodiments of the present disclosure provide systems and methods for data correction that allow for error tracing in a training dataset at an intra-sample and a sub-sample level. According to some aspects of the present disclosure, a system includes an influence component and a modification component. In some cases, the influence component identifies a false label (e.g., an incorrectly predicted label) from among a plurality of predicted labels corresponding to different parts of an input sample, wherein the plurality of predicted labels is generated by a neural network trained based on a training set comprising a plurality of training samples and a plurality of training labels corresponding to parts of the plurality of training samples.

In some cases, the influence component computes an influence of each of the plurality of training labels on the false label by approximating a change in a conditional loss for the neural network corresponding to each of the plurality of training labels.

In some cases, the modification component identifies a part of a training sample of the plurality of training samples and a corresponding source label from among the plurality of training labels based on the computed influence. In some cases, the modification component modifies the training set based on the identified part of the training sample and the corresponding source label to obtain a corrected training set.

Accordingly, aspects of the present disclosure identify a part of a training sample and a corresponding source label that has caused a neural network to predict an incorrect label for a part of a validation sample. In some cases, aspects of the present disclosure identify the causal relation between the part of a training sample, the corresponding source label, and the incorrect label by computing an influence of each of a plurality of training labels on the incorrect label by approximating a change in a conditional loss for the neural network corresponding to each of the plurality of training labels.

Aspects of the present disclosure provide a user interface that allows a user to provide a corrected label corresponding to a part of a training sample that has influenced the neural network to predict the incorrect label. In some cases, a corrected label is a corrected annotation corresponding to a part of a training sample that a user provided to replace a source label via a user interface. According to some aspects, the system then corrects the training set using the corrected label to obtain a corrected training set. In some cases, the corrected training set can be used in downstream applications, such as re-training the neural network to increase the predictive accuracy of the neural network. Therefore, embodiments of the present disclosure allow a user to quickly and easily diagnose an incorrect prediction made by the neural network at an intra-sample level, thereby decreasing the time and effort involved in collecting a training dataset that is suitable for training an accurate neural network.

An embodiment of the present disclosure is used in a data re-annotation context. For example, a system according to an aspect of the present disclosure identifies training data that influences a neural network to make an incorrect prediction for an input sample. The system displays the training data so that a user can review the training data and provide a correction input to the system. The system then corrects the training data in response to the correction input.

A frequent practice to correct erroneous machine learning models is to revisit a data annotation strategy, and typically to reannotate an entire dataset. However, by identifying a mistake made by a neural network on an input sample, the system can trace the error back to a subset of influential training examples, thereby reducing the amount of data that a user would consider for re-annotation. Furthermore, as the error-tracing is performed at a sub-sample level, the system can identify parts of a sample that need to be re-annotated. Not only does this provide transparency and a degree of causality for the neural network's predictions, but also allows for smarter and more targeted re-annotation of training data, thereby reducing re-annotation costs.

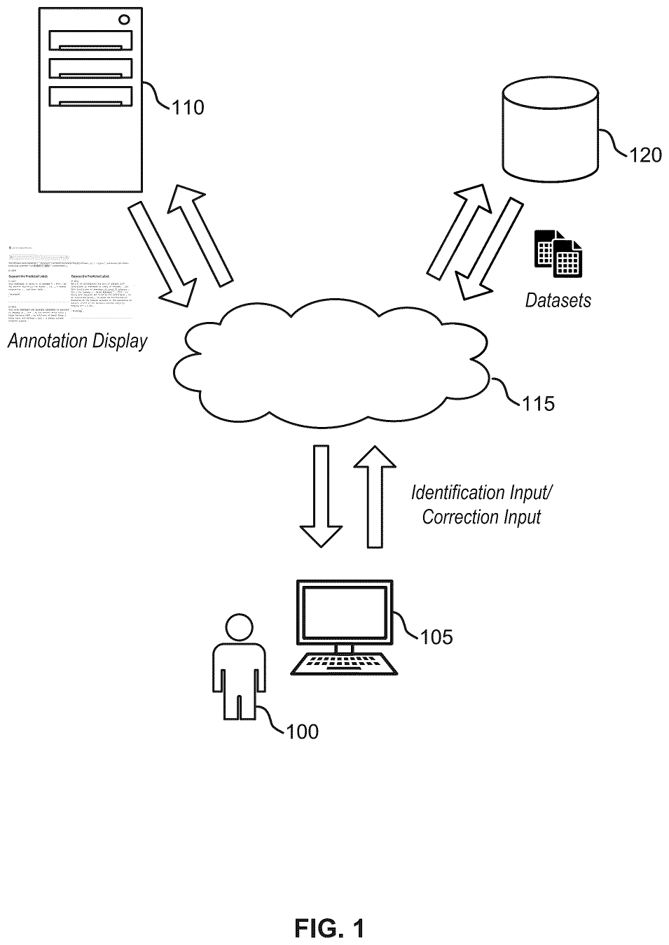

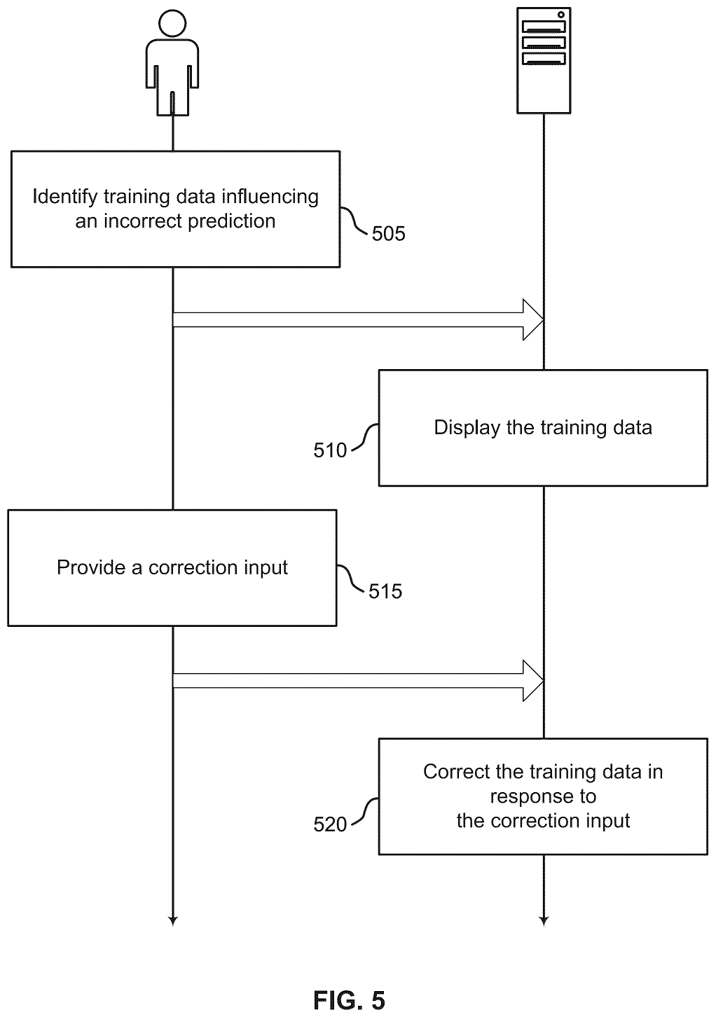

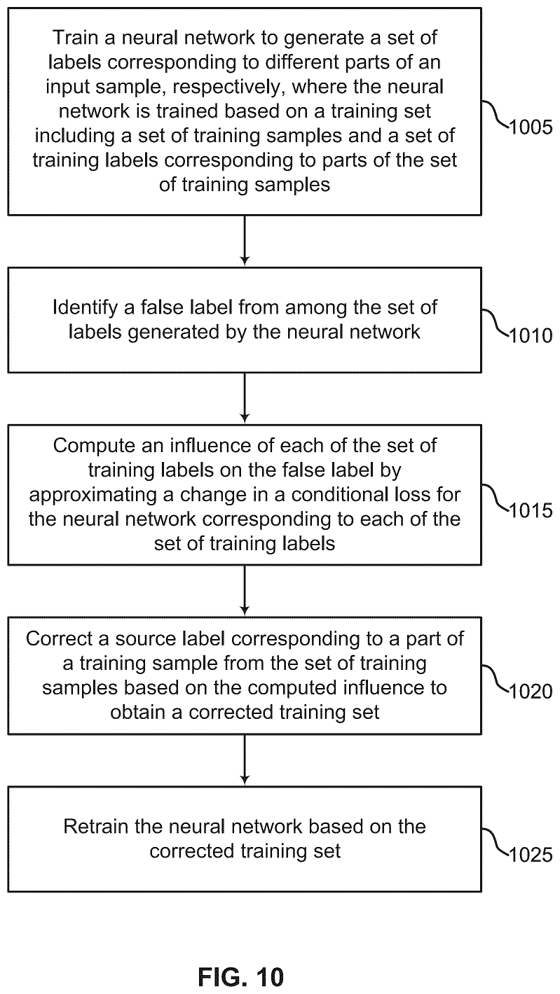

Example applications of the present disclosure in the data re-annotation context are provided with reference to FIGS. 1 and 5. Details regarding the architecture of the system are provided with reference to FIGS. 1-4. Examples of a process for data correction are provided with reference to FIGS. 5-9. Examples of a process for retraining a neural network are provided with reference to FIG. 10.

### Data Correction System

A system and apparatus for data correction is described with reference to FIGS. 1-4. One or more aspects of the system and apparatus include a processor; a memory including instructions executable by the processor; a neural network trained to generate labels corresponding to different parts of an input; and an influence component configured to compute an influence of each of a plurality of training labels on a target label by approximating a change in a conditional loss for the neural network corresponding to each of the plurality of training labels.

Some examples of the system and apparatus further include a modification component configured to identify the target label or a part of the input corresponding to the target label and to correct a training label of the plurality of training labels that influence the target label.

Some examples of the system and apparatus further include a user interface, wherein the modification component is further configured to receive the input identifying the target label or the part of the input corresponding to the target label via the user interface and to receive the input correcting the training label of the plurality of training labels that influence the target label via the user interface.

Some examples of the system and apparatus further include a user interface, wherein the influence component is further configured to display the labels corresponding to the different parts of the input via the user interface.

FIG. 1 shows an example of a data correction system according to aspects of the present disclosure. The example shown includes user 100, user device 105, data correction apparatus 110, cloud 115, and database 120.

Referring to FIG. 1, data correction apparatus 110 retrieves datasets from database 120. In some cases, data correction apparatus 110 retrieves a training set from database to train a neural network to predict annotations for parts of training samples included in the training set. In some cases, data correction apparatus 110 retrieves a validation set including an input sample and provides the input sample to the neural network to predict a label for a part of the input sample. In some cases, the neural network predicts a false label for the part of the input sample, and in response to identifying the false label, computes an influence of a part of a training sample and a corresponding source label included in the training set on the false label. In some cases, a false label is a label predicted by the neural network for an input sample that is different from a ground-truth label for the input sample. In some cases, the false label is identified by comparing the false label predicted by the neural network with the ground-truth label. In some examples, a false label labels less than an entire part of an input sample, while a corresponding ground-truth label labels the entire part of the input sample.

In some cases, user 100 can provide an identification input to a user interface of data correction apparatus 110 via user device 105 to identify the false label. In some cases, data correction apparatus 110 provides an annotation display via the user interface that displays the influential part of the training sample and the corresponding source label to user 100 via the user interface. In some cases, user 100 can provide a correction input to the user interface of data correction apparatus 110 via user device 105 instructing data correction apparatus 110 to re-annotate the influential part of the training sample using the correction input. In some cases, data correction apparatus 110 replaces the corresponding source label with the correction input to obtain a corrected training set.

According to some aspects, user device 105 is a personal computer, laptop computer, mainframe computer, palmtop computer, personal assistant, mobile device, or any other suitable processing apparatus. In some examples, user device 105 includes software that displays a user interface provided by data correction apparatus 110. In some aspects, the user interface allows user 100 to provide a correction input to data correction apparatus 110. In some aspects, the user interface displays validation samples, training samples, and annotations of the samples to user 100.

According to some aspects, a separate user interface enables user 100 to interact with user device 105. In some embodiments, the separate user interface includes an audio device, such as an external speaker system, an external display device such as a display screen, or an input device (e.g., a remote control device interfaced with the user interface directly or through an IO controller module). In some cases, the separate user interface is a graphical user interface (GUI).

According to some aspects, data correction apparatus 110 includes a computer implemented network. In some embodiments, the computer implemented network includes an artificial neural network (ANN). In some embodiments, data correction apparatus 110 also includes one or more processors, a memory subsystem, a communication interface, an I/O interface, one or more user interface components, and a bus. Additionally, in some embodiments, data correction apparatus 110 communicates with user device 105 and database 120 via cloud 115.

In some cases, data correction apparatus 110 is implemented on a server. A server provides one or more functions to users linked by way of one or more of various networks, such as cloud 115. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general purpose computing device, a personal computer, a laptop computer, a mainframe computer, a supercomputer, or any other suitable processing apparatus.

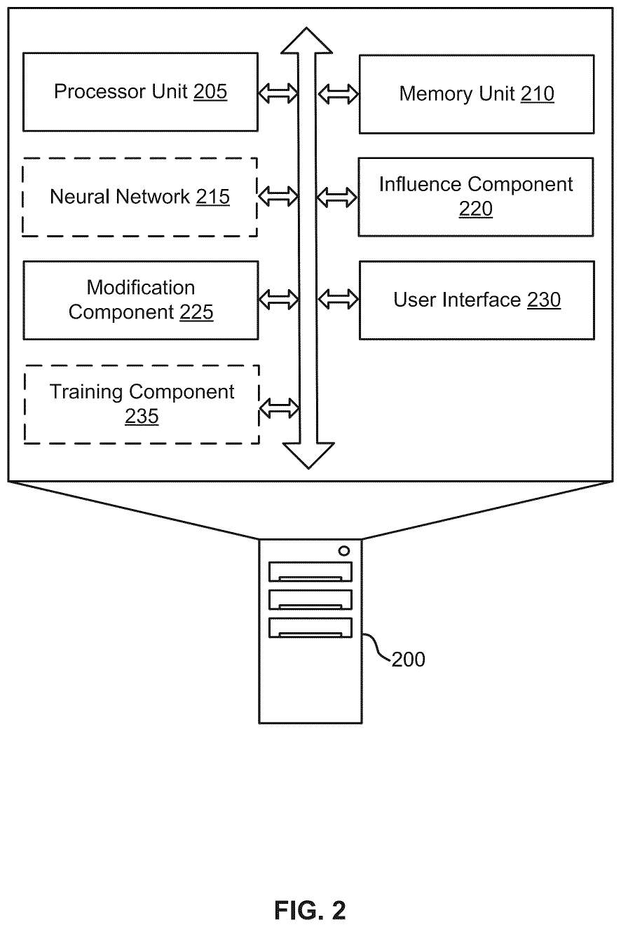

Data correction apparatus 110 is an example of, or includes aspects of, the corresponding element described with reference to FIG. 2. Further detail regarding the architecture of data correction apparatus 110 is provided with reference to FIGS. 2-4. Further detail regarding a process for data correction is provided with reference to FIGS. 5-9. Further detail regarding a process for retraining a neural network is provided with reference to FIG. 10.

Cloud 115 is a computer network configured to provide on-demand availability of computer system resources, such as data storage and computing power. In some examples, cloud 115 provides resources without active management by user 100. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location. According to some aspects, cloud 115 provides communications between user device 105, data correction apparatus 110, and database 120.

Database 120 is an organized collection of data. In an example, database 120 stores data in a specified format known as a schema. According to some aspects, database 120 is structured as a single database, a distributed database, multiple distributed databases, or an emergency backup database. In some cases, a database controller manages data storage and processing in database 120. In some cases, user 100 interacts with the database controller. In other cases, the database controller operates automatically without interaction from user 100. In some aspects, database 120 is external to data correction apparatus 110 and communicates with data correction apparatus 110 via cloud 115. In some embodiments, database 120 is included in data correction apparatus 110.

FIG. 2 shows an example of a data correction apparatus 200 according to aspects of the present disclosure. Data correction apparatus 200 is an example of, or includes aspects of, the corresponding element described with reference to FIG. 1. In one aspect, data correction apparatus 200 includes processor unit 205, memory unit 210, neural network 215, influence component 220, modification component 225, user interface 230, and training component 235.

According to some aspects, processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some embodiments, processor unit 205 includes special purpose components for modem processing, baseband processing, digital signal processing, or transmission processing.

According to some aspects, memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, neural network 215 generates the false label. According to some aspects, neural network 215 is trained to generate labels corresponding to different parts of an input.

According to some aspects, neural network 215 comprises one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

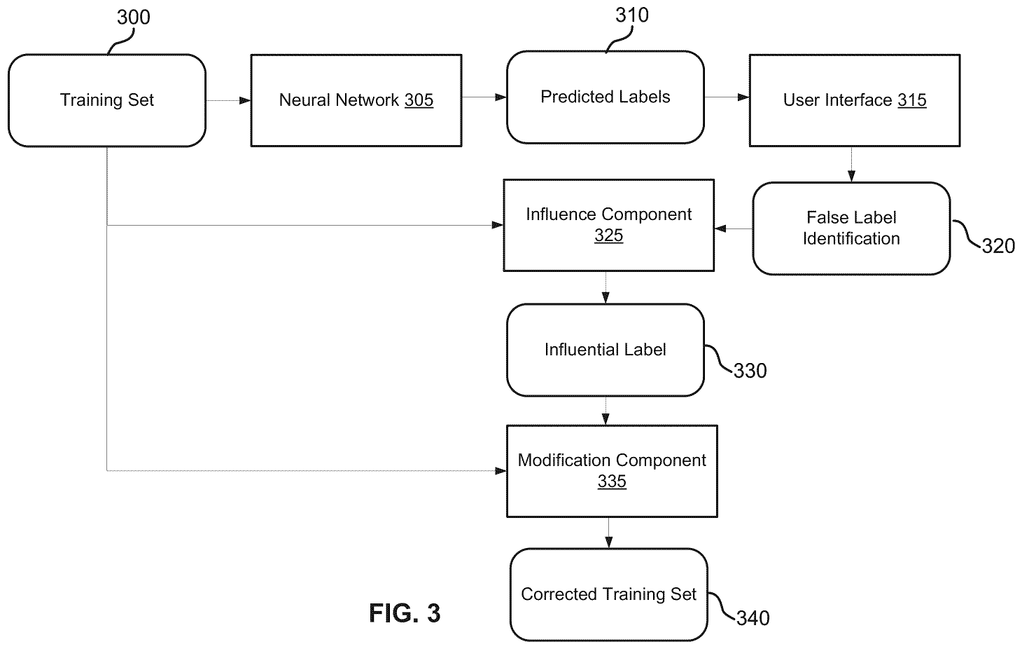

According to some aspects, neural network 215 is implemented as software stored in memory unit 210 and executable by processor unit 205, as firmware, as one or more hardware circuits, or as a combination thereof. According to some aspects, neural network 215 is omitted from data correction apparatus 200 and is included in an external device that communicates with data correction apparatus 200 via a communication protocol and a communication network, such as the cloud described with reference to FIG. 1. According to some aspects, neural network 215 is implemented in the external device as software stored in a memory and executable by a processor, as firmware, as one or more hardware circuits, or as a combination thereof. Neural network 215 is an example of, or includes aspects of, the corresponding element described with reference to FIG. 3.

According to some aspects, influence component 220 identifies a false label from among a set of predicted labels corresponding to different parts of an input sample, where the set of predicted labels is generated by a neural network 215 trained based on a training set including a set of training samples and a set of training labels corresponding to parts of the set of training samples. In some examples, influence component 220 computes an influence of each of the set of training labels on the false label by approximating a change in a conditional loss for the neural network 215 corresponding to each of the set of training labels.

In some examples, influence component 220 displays the input sample and the set of predicted labels in a user interface 230. In some examples, influence component 220 receives a user input identifying the false label from among the set of predicted labels via the user interface 230.

In some examples, influence component 220 selects a validation set corresponding to the training set, where the validation set includes the input sample and a ground-truth label for the input sample. In some examples, influence component 220 compares the false label to the ground-truth label, where the false label is identified based on the comparison.

In some examples, influence component 220 applies a non-zero weight to the conditional loss for the part of the training sample. In some examples, influence component 220 computes a gradient of the conditional loss for the part of the training sample, where the change in the conditional loss is approximated based on the non-zero weight and the gradient. In some examples, influence component 220 stores the gradient of the conditional loss during training of the neural network 215.

In some examples, influence component 220 identifies a set of encoder output weights and a set of class transition parameters, where the influence is approximated based on the set of encoder output weights and is independent of the class transition parameters. In some aspects, the input sample includes a text sample and the false label corresponds to a phrase of the text sample.

According to some aspects, influence component 220 identifies a false label from among the set of labels generated by the neural network 215. In some examples, influence component 220 computes an influence of each of the set of training labels on the false label by approximating a change in a conditional loss for the neural network 215 corresponding to each of the set of training labels.

In some examples, influence component 220 selects a validation set corresponding to the training set, where the validation set includes the input sample and a ground-truth label for the input sample. In some examples, influence component 220 compares the false label to the ground-truth label, where the false label is identified based on the comparison.

In some examples, influence component 220 applies a non-zero weight to the conditional loss for the part of the training sample. In some examples, influence component 220 computes a gradient of the conditional loss for the part of the training sample, where the change in the conditional loss is approximated based on the non-zero weight and the gradient.

In some examples, influence component 220 displays the input sample and the set of predicted labels in a user interface 230. In some examples, influence component 220 receives a user input identifying the false label from among the set of predicted labels via the user interface 230.

According to some aspects, influence component 220 is configured to compute an influence of each of a plurality of training labels on a target label by approximating a change in a conditional loss for the neural network 215 corresponding to each of the plurality of training labels.

According to some aspects, influence component 220 is implemented as software stored in memory unit 210 and executable by processor unit 205, as firmware, as one or more hardware circuits, or as a combination thereof. Influence component 220 is an example of, or includes aspects of, the corresponding element described with reference to FIG. 3.

According to some aspects, modification component 225 identifies a part of a training sample of the set of training samples and a corresponding source label from among the set of training labels based on the computed influence. In some examples, modification component 225 modifies the training set based on the identified part of the training sample and the corresponding source label to obtain a corrected training set.

In some examples, modification component 225 displays the part of the training sample and the corresponding source label in a user interface 230. In some examples, modification component 225 receives a user input identifying the part of the training sample or the corresponding source label, where the part of the training sample and the source label are identified based on the user input.

In some examples, modification component 225 receives a corrected label via user interface 230. In some examples, modification component 225 replaces the source label with the corrected label, where the corrected training set includes the corrected label.

According to some aspects, modification component 225 corrects a source label corresponding to a part of a training sample from the set of training samples based on the computed influence to obtain a corrected training set.

In some examples, modification component 225 displays the part of the training sample and the corresponding source label in a user interface 230. In some examples, modification component 225 receives a user input identifying the part of the training sample or the corresponding source label, where the part of the training sample and the source label are identified based on the user input.

In some examples, modification component 225 receives a corrected label via user interface 230. In some examples, modification component 225 replaces the source label with the corrected label, where the corrected training set includes the corrected label.

According to some aspects, modification component 225 is configured to identify the target label or a part of the input corresponding to the target label and to correct a training label of the plurality of training labels that influence the target label.

According to some aspects, modification component 225 is implemented as software stored in memory unit 210 and executable by processor unit 205, as firmware, as one or more hardware circuits, or as a combination thereof. Modification component 225 is an example of, or includes aspects of, the corresponding element described with reference to FIG. 3.

According to some aspects, user interface 230 is configured to receive the input identifying the target label or the part of the input corresponding to the target label via the user interface 230 and to receive the input correcting the training label of the plurality of training labels that influence the target label. In some examples, user interface 230 is configured to display the labels corresponding to the different parts of the input.

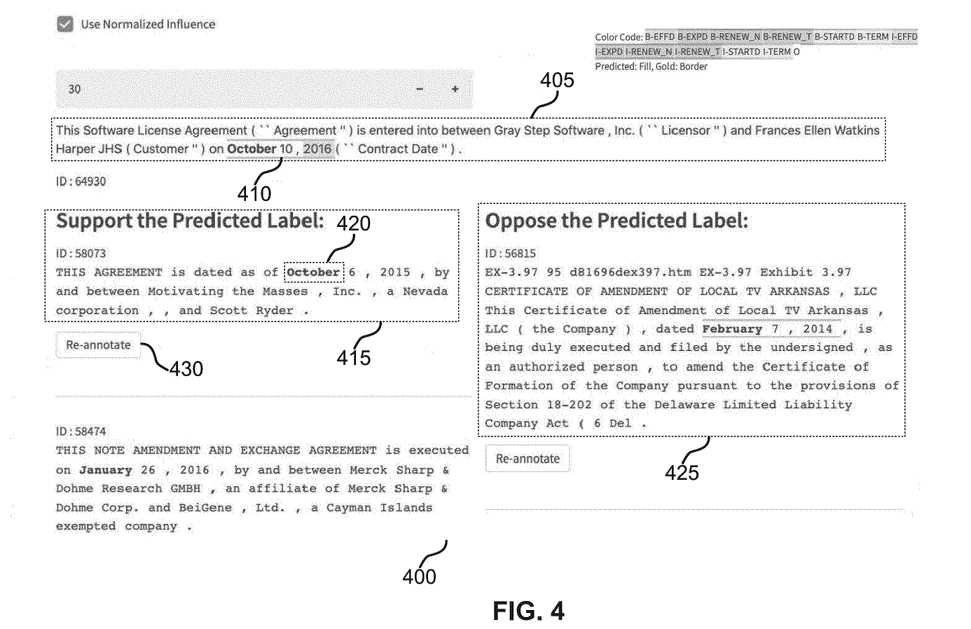

According to some aspects, user interface 230 is implemented as software stored in memory unit 210 and executable by processor unit 205. User interface 230 is an example of, or includes aspects of, the corresponding element described with reference to FIGS. 3 and 4.

According to some aspects, training component 235 trains neural network 215 based on a training set comprising a plurality of training samples and a plurality of training labels corresponding to parts of the plurality of training samples. According to some aspects, training component 235 retrains the neural network 215 based on the corrected training set.

According to some aspects, training component 235 trains neural network 215 to generate a set of labels corresponding to different parts of an input sample, respectively, where neural network 215 is trained based on a training set including a set of training samples and a set of training labels corresponding to parts of the set of training samples. In some examples, training component 235 retrains neural network 215 based on the corrected training set.

According to some aspects, training component 235 is implemented as software stored in memory unit 210 and executable by processor unit 205, as firmware, as one or more hardware circuits, or as a combination thereof. According to some aspects, training component 235 is omitted from data correction apparatus 200 and is included in an external device that communicates with data correction apparatus 200 via a communication protocol and a communication network, such as the cloud described with reference to FIG. 1. According to some aspects, training component 235 is implemented in the external device as software stored in a memory and executable by a processor, as firmware, as one or more hardware circuits, or as a combination thereof.

FIG. 3 shows an example of data flow in a data correction system according to aspects of the present disclosure. The example shown includes training set 300, neural network 305, predicted labels 310, user interface 315, false label identification 320, influence component 325, influential label 330, modification component 335, and corrected training set 340.

Neural network 305 is an example of, or includes aspects of, the corresponding element described with reference to FIG. 2. User interface 315 is an example of, or includes aspects of, the corresponding element described with reference to FIGS. 2 and 4. Influence component 325 is an example of, or includes aspects of, the corresponding element described with reference to FIG. 2. Modification component 335 is an example of, or includes aspects of, the corresponding element described with reference to FIG. 2.

Referring to FIG. 3, according to some aspects, neural network 305 generates predicted labels 310 based on training set 300. User interface 315 displays predicted labels 310 and receives false label identification 320, thereby identifying a false label among predicted labels 310.

According to some aspects, influence component 325 receives false label identification 320 from user interface 315 and identifies influential label 330 based on training set 300 and the false label corresponding to false label identification 320. In some cases, influential label 330 is a training label included in training set 300 that most influenced neural network 305 to predict the false label.

According to some aspects, modification component 335 receives influential label 330 and generates corrected training set 340 based on training set 300, wherein corrected training set 340 omits influential label 330, includes the remaining labels included in training set 300, and includes a corrected label.

FIG. 4 shows an example of a user interface according to aspects of the present disclosure. User interface 400 is an example of, or includes aspects of, the corresponding element described with reference to FIGS. 2 and 3. In one aspect, user interface 400 includes input sample 405, false label 410, supporting sample 415, supporting part 420, opposing sample 425, and correction element 430.

Referring to FIG. 4, user interface 400 allows users to examine samples and select a part within a sample to view a correspondence of the part to a false label predicted by a neural network. It then traces the false label to a particular training sample, and provides an interface to flag the samples for re-annotation. For example, input sample 405 comprises a text sample including a part comprising a phrase including the tokens “Oct. 10, 2016”. The part corresponds to false label 410. False label 410 is false because only the token “2016” is labeled as an Effective Date, as indicated by the filled border surrounding “2016”, rather than the entire part, as indicated by the unfilled border surrounding the tokens “October 10”. In other words, false label 410 is an incorrectly predicted label for the part “Oct. 10, 2016”.

User interface 400 allows a user to provide an input to user interface 400 that prompts user interface 400 to display training labels that have influenced false label 410, based on an influence computed by an influence component as described with reference to FIGS. 2 and 3. For example, the user may select the token “October” to see examples of parts of training samples (e.g., “Oct. 6, 2015” and “Jan. 26, 2016”) that are respectively associated with incorrect source labels and have influenced the neural network to incorrectly predict false label 410. In some cases, user interface 400 includes correction element 430 (such as a “re-annotate” button) that allows a user to provide a corrected label to the system.

According to some aspects, user interface 400 allows the user to select input sample 405 corresponding to false label 410 so that the prediction of false label 410 can be traced to training data-points. In some cases, if the user is interested in discovering a causal reasoning behind the neural network's erroneous prediction of false label 410, the user can select incorrectly predicted false label 410. Furthermore, given an intra-sample nature of the present disclosure, the user is able to select the entire input sample 405 as well as individual parts (such as tokens, bounding-boxes, phrases, etc.) of input sample 405. For example, the bolded word “October” is a selectable part of input sample 405. Upon receiving a selection of the part of input sample 405, user interface 400 surfaces two sets of training samples with K parts each, where K is hyperparameter that can be input to the system, along with ground-truth annotations corresponding to the K parts.

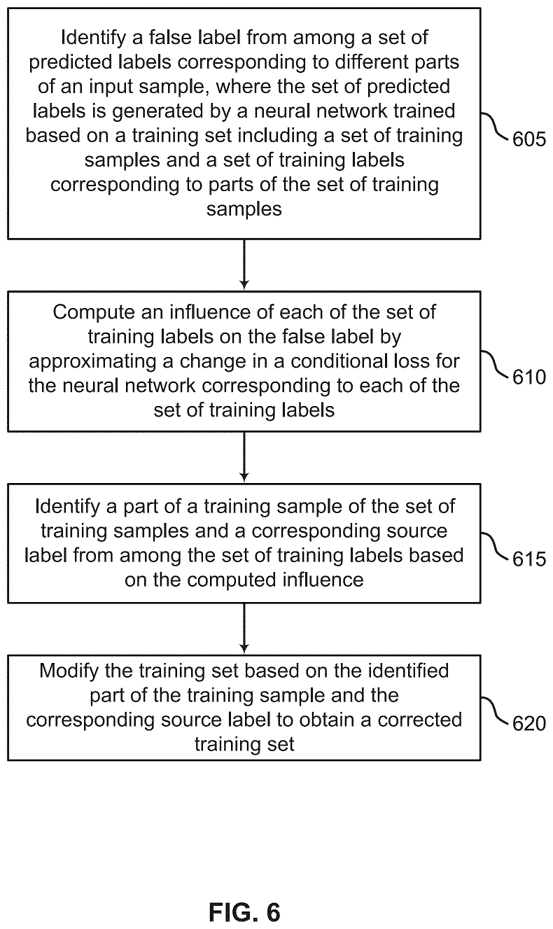

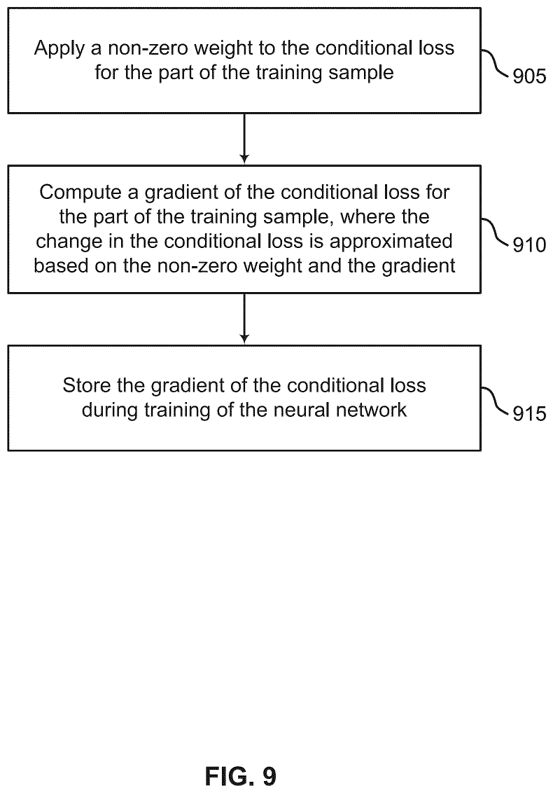

In some cases, the first set of training samples, including supporting sample 415, support the neural network's prediction of false label 410. In some cases, user interface 400 highlights parts of the training samples (such as tokens, bounding-boxes, etc.) within the training samples that are most influential for false label 410, as determined by the influence component as described with reference to FIGS. 6 and 9. For example, supporting sample 415 includes supporting part 420. Supporting part 420 is determined to be influential on false label 410. Supporting part 420 corresponds to an incorrect source label. In this case, the source label is incorrect because it does not label supporting part 420 as an “Effective Date”.

Further training the neural network on a training set including the source label corresponding to supporting part 420 would likely increase the neural network's confidence in its current incorrect prediction of false label 410. On the other hand, removing the source label corresponding to supporting part 420 from the training set and introducing a corrected label to the training set via correction element 430, thereby obtaining a corrected training set as described with reference to FIG. 6, may make the neural network less confident with respect to its current incorrect prediction of false label 410, and therefore might result in the neural network overturning the incorrect prediction. Accordingly, in some cases, user interface 400 allows for such source labels to be flagged for exclusion from the training set or for re-annotation.

In some cases, the second set of training samples, including opposing sample 425, oppose the neural network's current prediction of false label 410, and highlight the most influential parts within the second set of training samples. Analogously to the first set of training samples, training the model further on the second set of training samples is likely to decrease the neural network's confidence for its current prediction of false label 410.

In some cases, in addition to considering the first and second sets of supporting and opposing samples separately, user interface 400 allows the user to easily spot synergies and inconsistencies between the first and second sets. For example, training samples that are very similar but are labeled in inconsistent way can be surfaced by the system via user interface 400 (such as samples labeled according to one schema being included in the first set of training samples, while samples labeled according to a different schema being included in the second set of training samples). According to some aspects, user interface 400 allows for such inconsistent training data-points to be flagged for human review, exclusion, or re-annotation.

### Data Correction

A method for data correction is described with reference to FIGS. 5-9. One or more aspects of the method include identifying a false label from among a plurality of predicted labels corresponding to different parts of an input sample, wherein the plurality of predicted labels is generated by a neural network trained based on a training set comprising a plurality of training samples and a plurality of training labels corresponding to parts of the plurality of training samples; computing an influence of each of the plurality of training labels on the false label by approximating a change in a conditional loss for the neural network corresponding to each of the plurality of training labels; identifying a part of a training sample of the plurality of training samples and a corresponding source label from among the plurality of training labels based on the computed influence; and modifying the training set based on the identified part of the training sample and the corresponding source label to obtain a corrected training set.

Some examples of the method further include displaying the input sample and the plurality of predicted labels in a user interface. Some examples further include receiving a user input identifying the false label from among the plurality of predicted labels via the user interface. Some examples of the method include displaying the part of the training sample and the corresponding source label in a user interface. Some examples further include receiving a user input identifying the part of the training sample or the corresponding source label, wherein the part of the training sample and the source label are identified based on the user input.

Some examples of the method further include receiving a corrected label via a user interface. Some examples further include replacing the source label with the corrected label, wherein the corrected training set includes the corrected label.

Some examples of the method further include selecting a validation set corresponding to the training set, wherein the validation set includes the input sample and a ground-truth label for the input sample. Some examples further include generating the false label using the neural network. Some examples further include comparing the false label to the ground-truth label, wherein the false label is identified based on the comparison.

Some examples of the method further include applying a non-zero weight to the conditional loss for the part of the training sample. Some examples further include computing a gradient of the conditional loss for the part of the training sample, wherein the change in the conditional loss is approximated based on the non-zero weight and the gradient. Some examples of the method further include storing the gradient of the conditional loss during training of the neural network.

Some examples of the method further include identifying a plurality of encoder output weights and a plurality of class transition parameters, wherein the influence is approximated based on the plurality of encoder output weights and is independent of the class transition parameters. In some aspects, the input sample comprises a text sample and the false label corresponds to a phrase of the text sample. Some examples of the method further include retraining the neural network based on the corrected training set.

FIG. 5 shows an example of data correction according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, the system identifies training data that influences a neural network to make an incorrect prediction for an input sample. The system displays the training data so that a user can review the training data and provide a correction input to the system. The system then corrects the training data in response to the correction input.

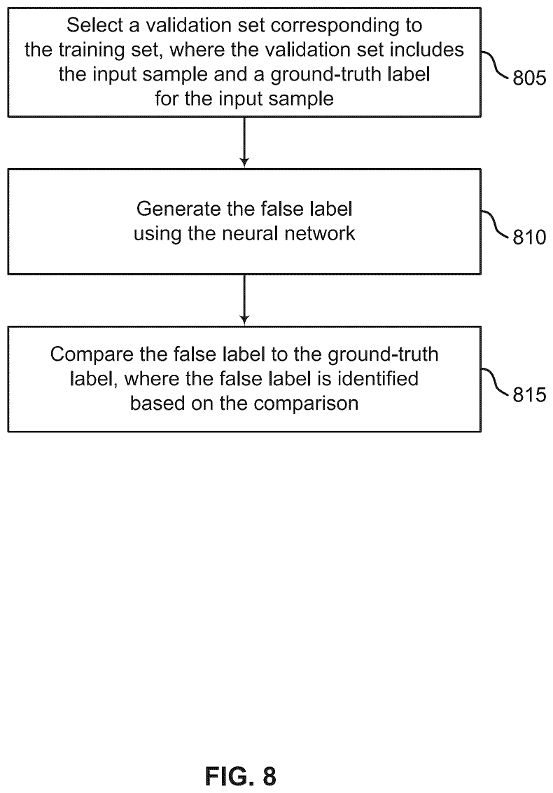

At operation 505, the system identifies training data influencing an incorrect prediction. In some cases, the operations of this step refer to, or may be performed by, a data correction apparatus as described with reference to FIG. 1. For example, in some cases, a neural network incorrectly predicts a false label based on an input sample as described with reference to FIGS. 6 and 8, and an influence component identifies the false label by comparing the false label to a ground-truth label as described with reference to FIGS. 6 and 8. In some cases, the influence component computes an influence of a training sample on the false label as described with reference to FIGS. 6 and 9, and identifies a training sample that influences the incorrect prediction of the false label as described with reference to FIGS. 6 and 9.

At operation 510, the system displays the training data. In some cases, the operations of this step refer to, or may be performed by, a data correction apparatus as described with reference to FIGS. 1 and 2. For example, in some cases, the influence component displays the identified training sample that influences the incorrect prediction via a user interface as described with reference to FIG. 6. An example of a user interface is described with reference to FIG. 4.

At operation 515, the user provides a correction input. In some cases, the operations of this step refer to, or may be performed by, a user as described with reference to FIG. 1. For example, in some cases, the user provides a corrected label to the system via the user interface as described with reference to FIG. 6.

At operation 520, the system corrects the training data in response to the correction input. In some cases, the operations of this step refer to, or may be performed by, a data correction apparatus as described with reference to FIGS. 1 and 2. For example, in some cases, a modification component adds the corrected label to the training data and removes the identified training sample from the training data to obtain corrected training data as described with reference to FIG. 6.

FIG. 6 shows an example of training set modification according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, according to some aspects, the system identifies a false label that is output by a neural network for a part of an input sample that is provided to the neural network and computes an influence that a part of a training sample and a corresponding source label has on the prediction of the false label. According to some aspects, the system provides a user interface that allows a user to provide a corrected label to replace the source label. According to some aspects, the system replaces the source label with the corrected label to obtain a corrected training sample.

At operation 605, the system identifies a false label from among a set of predicted labels corresponding to different parts of an input sample, where the set of predicted labels is generated by a neural network trained based on a training set including a set of training samples and a set of training labels corresponding to parts of the set of training samples. In some cases, the operations of this step refer to, or may be performed by, an influence component as described with reference to FIGS. 2 and 3.

According to some aspects, the neural network ƒ_{θ} is trained to assign to each sample xᵢₜ∈V in an input sequence xᵢ (of length Tᵢ) a label yᵢₜ from a label set Y. In some cases, the training set is denoted by D, where [symbol] ={(xᵢ={xᵢₜ}ₜ₌₁^{T}^{ᵢ}, yᵢ={yᵢₜ}ₜ₌₁^{T}^{ᵢ})}.

In some cases, the neural network ƒ_{θ} is a model that yields conditional probability estimates for sequence label assignments: p_{θ} (yᵢ|xᵢ). For example, given parameter estimates \hat{θ}, the neural network can make a prediction for a test instance xᵢ by selecting the most likely y:ŷᵢ=argmaxᵤ p_{\hat{θ}}(y|xᵢ). In some cases, such as structured prediction tasks, the label yᵢₜ is based in part on labels yᵢ\yᵢₜ, given the input xᵢ. In some cases, such as linear chain sequence tagging, the association of the label yᵢₜ with the labels yᵢ\yᵢₜ given the input xᵢ is formalized as a graphical model in which adjacent labels are connected.

According to some aspects, parameters θ of the neural network ƒ_{θ} are typically estimated by minimizing the negative log-likelihood loss of the training dataset D:

$${arg min}_{θ} \frac{1}{\vert 𝒟 \vert} {\sum }_{( {x}_{i} , {y}_{i} ) ∈ 𝒟} - log {p}_{θ} ( {y}_{i} \vert {x}_{i} ) \qquad ( 1 )$$

The term “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In some cases, the loss (e.g., the negative log likelihood) of an example zᵢ=(xᵢ, yᵢ) is expressed as [symbol] (zᵢ, θ)=−log p_{θ}(yᵢ|xᵢ), and the overall loss over the training set is expressed by

$$ℒ ( 𝒟 , θ ) = \frac{1}{\vert 𝒟 \vert} {\sum }_{{z}_{i} ∈ 𝒟} ℒ ( {z}_{i} , θ ) .$$

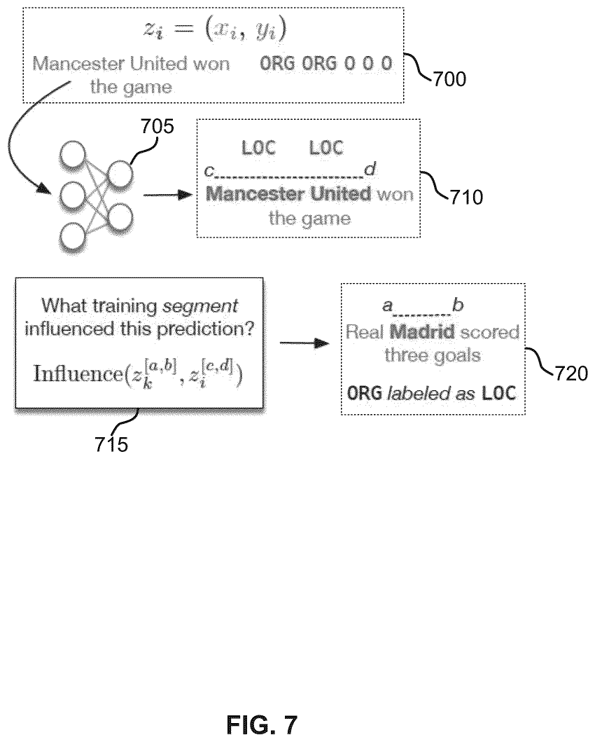

According to some cases, the input sample comprises a text sample and the false label corresponds to a phrase of the text sample. For example, referring to FIG. 7, an input sample can include a phrase of tokens, such as “Manchester United won the game”. In some cases, each token or group of tokens is a part of the input sample, and each part of the input sample can correspond to a predicted label and to a source label included in a validation data set. For example, referring to FIG. 7, a part of the input sample includes the tokens “Manchester United”, the part corresponds to a source label (e.g., a ground-truth label) of ORG (for Organization), and the part is predicted by neural network 705 to correspond to a label of LOC (for Location) (e.g., a false label). As used herein, a false label refers to an incorrectly predicted label that does not match an expected prediction. For example, LOC is a false label because it does not match the ground-truth label, ORG. According to some aspects, the influence component identifies the false label as described with reference to FIG. 8.

According to some aspects, the influence component retrieves the false label and the plurality of predicted labels from the neural network and retrieves the input sample from a database, such as the database described with reference to FIG. 1. According to some aspects, the influence component displays the input sample and the plurality of predicted labels in a user interface (such as the user interface described with reference to FIGS. 2 and 3) and receives a user input identifying the false label from among the plurality of predicted labels in the user interface. For example, referring to FIG. 4, user interface 400 displays input sample 405. A user can provide an input to a selected part of input sample 405 to prompt the influence component to display a label corresponding to the selected part via user interface 400. In the case of 400, the label corresponding to the selected part is a false label.

At operation 610, the system computes an influence of each of the set of training labels on the false label by approximating a change in a conditional loss for the neural network corresponding to each of the set of training labels. In some cases, the operations of this step refer to, or may be performed by, an influence component as described with reference to FIGS. 2 and 3.

According to some aspects, the influence component computes a part-level influence of each of the set of training labels on the false label. For example, in some cases, the influence component quantifies an impact of training sample parts Xₖ[a, b] (corresponding to labels y_{k[a,b]}) 1≤a, b≤Tₖ on the loss of an input sample zᵢ. Accordingly, in some cases, an influence is a value that quantifies a degree to which a training sample causes a neural network to make a prediction. Named entity recognition (NER) is a subtask of information extraction that locates and classifies named entities mentioned in a text input. In the NER context, a part corresponds to an entity.

According to some aspects, the exact influence of a part [a, b] within a training sample zₖ on a part [c, d] of an input sample zᵢ=(xᵢ, yᵢ) is a change in loss that would be observed for reference token labels in part [c, d] of zᵢ, when the labels for part [a, b] within zₖ are excluded from the training data.

According to some aspects, in a partial annotation training context, zₖ=(xₖ={xₖ₁, . . . , x_{kT}_{ₖ}}, yₖ={yₖ₁, . . . , y_{kT}_{ₖ}}) In some cases, when there are no labels for part [a, b] in yₖ (for instance, {yₖ₁, . . . , y_{kb}} labels are missing), a partial label sequence is denoted by yₖ^{-[a,b]}=yₖ\{yₖₐ, . . . , y_{kb}}, where yₖ^{[a,b]}={yₖₐ, . . . , y_{kb}}. In some cases, the influence component marginalizes over all possible label assignments to the part [a, b] when computing the likelihood of this training example:

$${p}_{θ} ( {y}_{k}^{- [ a , b ]} \vert {x}_{k} ) = {\sum }_{{y}_{a}^{′} ∈ 𝒴} … {\sum }_{{y}_{b}^{′} ∈ 𝒴} {p}_{θ} ( {y}_{k}^{- [ a , b ]} ⋃ \{ {y}_{a}^{′} , … , {y}_{b}^{′} \} \vert {x}_{k} ) \qquad ( 2 )$$

In this case, the influence component determines the marginal loss [symbol] of the partially annotated sequence:

[symbol]

(zₖ^{-[a,b]}, θ)=−log p_{θ}(yₖ^{-[a,b]}|xₖ) (3)

In some cases, the influence component determines the marginal loss [symbol] as a difference between a joint loss of yₖ and a conditional loss [symbol] of the part yₖ^{[a,b]}:

log p_{θ}(yₖ^{-[a,b]}|xₖ)=log p_{θ}(yₖ|xₖ)−log p_{θ}(yₖ^{[a,b]}|yₖ^{-[a,b]}, xₖ) (4)

[symbol]

(zₖ^{-[a,b]}, θ)= [symbol] (zₖ, θ)− [symbol] (zₖ^{[a,b]}, θ) (5)

In some cases, the influence component determines the conditional loss [symbol] of the part [a,b]:

[symbol]

(zₖ^{[a,b]}, θ)=−log p_{θ}(yₖ^{[a,b]}|yₖ^{-[a,b]}, xₖ) (6)

According to some aspects, the influence component uses equation (5) to

approximate an influence via E-weighting.

Accordingly, a change in loss for a part of an input sample is zᵢ=(xᵢ, yᵢ), and a loss for the segment [c, d] of the output yᵢ is the conditional loss of the segment [c, d]: [symbol] (zᵢ^{[c,d]}, θ).

According to some aspects, the exact influence of part [a, b] of zₖ would be computed by first retraining the neural network ƒ_{θ} without the part [a, b] of training sample zₖ:

$$\hat{θ} [ {z}_{k}^{- [ a , b ]} ] = {argmin}_{θ} \frac{1}{\vert 𝒟 \vert} {\sum }_{{z}_{l} ∈ 𝒟} ℒ ( {z}_{l} , θ ) - \frac{1}{\vert 𝒟 \vert} ( ℒ ( {z}_{k} , θ ) - ℳℒ ( {z}_{k}^{- [ a , b ]} , θ ) ) \qquad ( 7 )$$

For example, comparing equations (5) and (7), removing the effect of segment [a, b] of zₖ is equivalent to subtracting the conditional loss of the part [symbol] (zₖ^{-[a,b]}, θ) from the original loss [symbol] (D, θ).

According to some aspects, the exact influence of part [a, b] of zₖ would then be determined by computing a difference between the conditional loss of segment [c, d] of input sample zᵢ under new parameter estimates \hat{θ} [zₖ^{-[a,b]}] and the original estimates trained using the objective of equation (1):

Exact-Influence (zₖ^{[a,b]}, zᵢ^{[c,d]})= [symbol] (zᵢ^{[c,d]}, \hat{θ}[zₖ^{-[a,b]}])− [symbol] (zᵢ^{[c,d]}, \hat{θ}) (8)

According to some aspects, to avoid retraining the neural network ƒ_{θ} to compute the influence of each of the set of training labels on the false label, the influence component approximates a change in a conditional loss for the neural network ƒ_{θ} corresponding to each of the set of training labels as described with reference to FIG. 9.

At operation 615, the system identifies a part of a training sample of the set of training samples and a corresponding source label from among the set of training labels based on the computed influence. In some cases, the operations of this step refer to, or may be performed by, a modification component as described with reference to FIGS. 2 and 3.

For example, according to some aspects, the influence component provides the

computed influence of the part [a,b] of each of the set of training labels and a corresponding source label of the set of training labels on the part [c,d] of the false label as described with reference to FIG. 9 to the modification component, and the modification component determines one or more parts of training samples that have the most influence on the false label based on the computed influence (for example, by determining a value output by equation h part [a,b] of each of the set of training labels on the part [c,d] of the false label).

According to some aspects, the modification component displays the part of the training sample and the corresponding source label in a user interface and receives a user input identifying the part of the training sample or the corresponding source label, where the part of the training sample and the source label are identified based on the user input. For example, in some cases, the modification component determines one or more training samples including one or more parts that most influence the false label, displays the one or more training samples including the one or more parts to the user via the user interface, and receives a user input identifying the part of the training sample or the corresponding source label via the user interface.

For example, referring to FIG. 4, user interface 400 displays a first set of training samples, including supporting sample 415, that support the neural network's prediction of false label 410. In some cases, user interface 400 highlights parts of the training samples (such as tokens, bounding-boxes, etc.) within the training samples that are most influential for false label 410. For example, supporting sample 415 includes supporting part 420. Supporting part 420 is determined to be influential on false label 410. Supporting part 420 corresponds to an incorrect source label. In this case, the source label is incorrect because it does not label supporting part 420 as an “Effective Date”.

At operation 620, the system modifies the training set based on the identified part of the training sample and the corresponding source label to obtain a corrected training set. In some cases, the operations of this step refer to, or may be performed by, a modification component as described with reference to FIGS. 2 and 3.

In some cases, the modification component receives a corrected label via the user interface and replaces the source label with the corrected label such that the corrected training set includes the corrected label. For example, in some cases, the user interface includes a correction element associated with the false label that allows a user to provide a corrected label to the modification component in response to a user input provided to the correction element. For example, in response to an input to the correction element, the user interface prompts the user to provide a corrected label for a selected part of a selected training sample.

According to some aspects, in response to receiving the corrected label via the user interface, the modification component removes the source label from the training set and associates the corrected label with the identified part of the training sample to obtain the corrected training set. In some cases, the modification component stores the corrected training set in a database, such as the database as described with reference to FIG. 1.

According to some aspects, a training component retrains the neural network based on the corrected training set. For example, in some cases, the training component retrieves the corrected training set from the modification component and/or the database and retrains the neural network based on the corrected training set as described with reference to FIG. 10.

FIG. 7 shows an example of identifying an influential text sample according to aspects of the present disclosure. The example shown includes input sample 700, neural network 705, incorrect prediction 710, influence function 715, and training sample 720.

Referring to FIG. 7, input sample 700 can include a phrase of tokens, such as “Manchester United won the game”. In this case, the phrase is associated with a ground-truth source label “ORG” (for “Organization”) that is included in a validation set. In some cases, neural network 705 outputs an incorrect prediction 710 including a false label for a part of input sample 700 that spans from index “c” to index “d”. In this case, the false label is “LOC” (for “Location”), and it is a false label because it does not match the ground-truth label “ORG”. According to some aspects, using influence function 715 as described with reference to FIGS. 6 and 8-9, the system identifies that a part of training sample 720 (spanning from index “a” to index “b”) influenced neural network 705 to make the incorrect prediction. In this case, part [a,b] of training sample 720 (“Madrid”) corresponds to an incorrect source label “LOC”, as opposed to a correct source label “ORG”.

FIG. 8 shows an example of false label identification according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system selects a validation set corresponding to the training set, where the validation set includes the input sample and a ground-truth label for the input sample. In some cases, the operations of this step refer to, or may be performed by, an influence component as described with reference to FIGS. 2 and 3. According to some aspects, the influence component selects the validation set from a database as described with reference to FIG. 1. In some cases, the ground-truth label is a label that the neural network is expected to output in response to receiving the input sample as an input. In some cases, the ground-truth label is a ground-truth annotation of a part of the input sample that the neural network predicts the false label to annotate.

At operation 810, the system generates the false label using the neural network. In some cases, the operations of this step refer to, or may be performed by, a neural network as described with reference to FIGS. 2 and 3. For example, in some cases, the influence component provides the input sample to the neural network and the neural network predicts the false label based on the training set in response to receiving the input sample. In some cases, the false label is an annotation of a part (such as a token, a phrase, a bounding box, etc.) of the input sample.

At operation 815, the system compares the false label to the ground-truth label, where the false label is identified based on the comparison. In some cases, the operations of this step refer to, or may be performed by, an influence component as described with reference to FIGS. 2 and 3. For example, in some cases, the influence component retrieves the false label from the neural network and compares the false label to the ground-truth label (for example, by determining a degree of similarity between the false label and the ground-truth label). In some cases, by comparing the false label to the ground-truth label, the influence component is able to determine that the false label is dissimilar to the ground-truth label representing the expected output of the neural network, and is therefore a false label (e.g., an incorrectly predicted label).

FIG. 9 shows an example of conditional loss approximation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 9, to avoid retraining the neural network ƒ_{θ} to compute the exact influence of each of the set of training labels on the false label as described with reference to equation (8), the influence component approximates a change in a conditional loss for the neural network ƒ_{θ} corresponding to each of the set of training labels.

At operation 905, the system applies a non-zero weight to the conditional loss for the part of the training sample. In some cases, the operations of this step refer to, or may be performed by, an influence component as described with reference to FIGS. 2 and 3.

For example, according to some aspects, the influence component uses an ϵ-unweighting method to approximate an influence of a part [a,b]. In some cases, using the ϵ-unweighting method, the influence component computes a change in model parameters for the neural network ƒ_{θ} if an additional penalty [symbol] (zₖ^{-[a,b]}, θ) is incurred for the part [a, b]:

$${\hat{θ}}_{ϵ} [ {z}_{k}^{- [ a , b ]} ] \& = {argmin}_{θ} \frac{1}{\vert 𝒟 \vert} {\sum }_{{z}_{l} ∈ 𝒟} ℒ ( {z}_{l} , θ ) + ϵ𝒞ℒ ( {z}_{k}^{- [ a , b ]} , θ ) \qquad ( 9 )$$

At operation 910, the system computes a gradient of the conditional loss for the part of the training sample, where the change in the conditional loss is approximated based on the non-zero weight and the gradient. In some cases, the operations of this step refer to, or may be performed by, an influence component as described with reference to FIGS. 2 and 3.

For example, according to some aspects, the influence component computes a first order approximation to the difference in the neural network parameters near ϵ=0:

$${\frac{d {\hat{θ}}_{ϵ} [ {z}_{k}^{- [ a , b ]} ]}{d ϵ} \vert}_{ϵ = 0} = - {H}^{- 1} {∇}_{θ} 𝒞ℒ ( {z}_{k}^{[ a , b ]} , \hat{θ} ) \qquad ( 10 )$$

In some cases, the influence component applies the chain rule to measure the change in the conditional loss over segment [c, d] of input sample zᵢ due to the first-order approximation:

$${I ( {z}_{i}^{[ c , d ]} , {z}_{k}^{[ a , b ]} ) = \frac{d 𝒞ℒ ( {z}_{i}^{[ c , d ]} , {\hat{θ}}_{ϵ} [ {z}_{k}^{[ a , b ]} ] )}{d ϵ} \vert}_{ϵ = 0} = - {∇}_{θ} 𝒞ℒ ( {z}_{i}^{[ c , d ]} , \hat{θ} ) {H}^{- 1} {∇}_{θ} 𝒞ℒ ( {z}_{i}^{[ a , b ]} , \hat{θ} ) \qquad ( 11 )$$

According to some aspects, equation (11) provides an approximation to the exact influence for a part of a training example on a part of an input sample as described with reference to FIG. 6. For example, the influence component uses equation (11) to compute the influence of a part [a,b] of each of the set of training labels on a part [c,d] of the false label.

According to some aspects, the influence component omits the Hessian term of equation (11) when computing the influence to simplify the computation.

According to some aspects, the influence component identifies a plurality of encoder output weights and a plurality of class transition parameters, where the influence is approximated based on the plurality of encoder output weights and is independent of the class transition parameters.

For example, in some cases, the influence component considers a restricted set of neural network parameters (such as those in a top linear layer of the neural network that produce classification logits) when computing the gradient for the influence in order to simplify equation (11). In some cases, wherein the neural network is a sequence tagging model built on top of a deep encoder F, a score function for the sequence tagging model is given by:

$$s ( {y}_{i} , {x}_{i} ) = {\sum }_{t = 1}^{{T}_{i}} {\underline{y}}_{it}^{T} W {F ( {x}_{i} )}_{t} + {\underline{y}}_{i ( t - 1 )}^{T} T {\underline{y}}_{it} \qquad ( 12 )$$

Referring to FIG. 12, T is a matrix of class transition scores, yᵢₜ is a one-hot representation of label yᵢₜ, and W are encoder output weights. A one-hot representation uses binary vectors to represent labels. For example, values in yᵢₜ are mapped to integer values, and each integer value is represented as a binary vector that includes all zero values except the index of the integer, which is marked with a 1. In some cases, a conditional random field (CRF) layer on top of the deep encoder F consumes scores produced by the score function and computes a probability of a label sequence:

$$p ( {y}_{i} \vert {x}_{i} ) = \frac{{e}^{s ( {y}_{i} , {x}_{i} )}}{{\sum }_{{y}^{′} ∈ {𝒴}^{{T}_{i}}} {e}^{s ( {y}^{′} , {x}_{i} )}} \qquad ( 13 )$$

In this case, the influence component considers the gradient only with respect to the W and T parameters above and not any parameters associated with F.

In some cases, the influence component computes a conditional likelihood under a CRF of a segment [a,b] for an instance (x,y):

$$p ( y \vert x ) = \frac{{e}^{s ( y , x )}}{Z ( x )} \qquad ( 14 )$$

$$p ( {y}^{- [ a , b ]} \vert x ) = {\sum }_{{y}_{a}^{′} ∈ 𝒴} … {\sum }_{{y}_{b}^{′} ∈ 𝒴} \frac{{e}^{s ( {y}^{′} , x )}}{Z ( x )} \qquad ( 15 )$$

$$p ( {y}_{[ a , b ]} \vert {y}_{- [ a , b ]} , x ) = p ( y \vert x ) = \frac{p ( y \vert x )}{p ( {y}^{- [ a , b ]} \vert x )} = \frac{{e}^{s ( y , x )}}{{\sum }_{{y}_{a}^{′} ∈ 𝒴} … {\sum }_{{y}_{a}^{′} ∈ {𝒴}^{{e}^{s ( {y}^{′} , x )}}}} \qquad ( 16 )$$

In some cases, Z(x) is the normalizer of a CRF equation that is independent of sequence labels (e.g., that depends only on x) and y′=y^{-[a,b]}∪{y′_{z} . . . y′_{b}}. In a linear chain CRF, the score function s(y, x) can be divided into sum of three parts, and therefore, e^{s(y,x)} can be written as a product of three parts. First, s^{-[a,b]}, including terms that depend on only y^{-[a,b]}, such as terms of the form yₜ^{T}WF(x)ₜ and yₜ₋₁^{T}Tyₜ, where t, t−1∉[a,b]. Second, s^{[a,b]}, including terms that depend on only y^{[a,b]}, such as terms of the form yₜ^{T}WF(x)ₜ and yₜ₋₁^{T}Tyₜ, where t, t−1∈[a, b]. Third, interaction terms T_{I}, including terms −yₐ₋₁^{T}Tyₐ and y_{b}^{T}Ty_{b+1}. Accordingly, in some cases, the influence component determines equation (16) as:

$$p ( {y}_{[ a , b ]} \vert {y}_{- [ a , b ]} , x ) = \frac{{e}^{s [ a , b ] + {T}_{I}}}{{\sum }_{{y}_{a}^{′} ∈ 𝒴} … {\sum }_{{y}_{a}^{′} ∈ {𝒴}^{{e}^{s [ a , b ] + {T}_{I}}}}} \qquad ( 17 )$$

In some cases, the influence component takes out the terms s^{-[a,b]} as they do not depend on any summation variables.

According to some aspects, the influence component simplifies equation (17) and applies the formula for a logarithm of a product:

$$P ( {y}_{t} \vert {y}_{- t} , x ) = \frac{{e}^{{\underline{y}}_{t - 1}^{T} T {\underline{y}}_{t} + {\underline{y}}_{t}^{T} W {F ( x )}_{t} + {\underline{y}}_{t}^{T} T {\underline{y}}_{t + 1}}}{{\sum }_{{y}_{t}^{′} ∈ {𝒴}^{{e}^{{\underline{y}}_{t - 1}^{T} T {\underline{y}}_{t} + {\underline{y}}_{t}^{T} W {F ( x )}_{t} + {\underline{y}}_{t}^{T} T {\underline{y}}_{t + 1}}}}} \qquad ( 18 )$$

$$log p ( {y}_{t} \vert {y}_{- t} , x ) = {\underline{y}}_{t - 1}^{T} T {\underline{y}}_{t} + {\underline{y}}_{t}^{T} W {F ( x )}_{t} + {\underline{y}}_{t}^{T} T {\underline{y}}_{t + 1} - log {\sum }_{{y}_{t}^{′} ∈ 𝒴} {e}^{{\underline{y}}_{t - 1}^{T} T {\underline{y}}_{t} + {\underline{y}}_{t}^{T} W {F ( x )}_{t} + {\underline{y}}_{t}^{T} T {\underline{y}}_{t + 1}} \qquad ( 19 )$$

Accordingly, in some cases, the influence component takes the gradient with respect to both emission parameters W (e.g., encoder output weights) and class transition parameters T, where ⊗ indicates an outer product of two vectors:

$${∇}_{w} log P ( {y}_{t} \vert {y}_{- t} , x ) = {\underline{y}}_{t} ⊗ {F ( x )}_{t} - {\sum }_{{y}_{t}^{′} ∈ 𝒴} P ( {y}_{t}^{′} \vert {y}_{- t} x ) {\underline{y}}_{t}^{′} ⊗ {F ( x )}_{t} = ( {\underline{y}}_{t} - {\sum }_{{y}_{t}^{′} ∈ 𝒴} p ( {y}_{t}^{′} \vert {y}_{- t} , x ) {\underline{y}}_{t}^{′} ) ⊗ {F ( x )}_{t} = {\underline{e}}_{t} ⊗ {F ( x )}_{t} \qquad ( 20 )$$

$${∇}_{T} log p ( {y}_{t} \vert {y}_{- t} , x ) = [ {\underline{y}}_{t - 1} ⊗ {\underline{y}}_{t} + {\underline{y}}_{t} ⊗ {\underline{y}}_{t + 1} ] - {\sum }_{{y}_{t}^{′} ∈ 𝒴} p ( {y}_{t}^{′} \vert {y}_{- t} , x ) [ {\underline{y}}_{t - 1} ⊗ {\underline{y}}_{t}^{′} + {\underline{y}}_{t}^{′} ⊗ {\underline{y}}_{t + 1} ] = {\underline{y}}_{t - 1} ⊗ ( {\underline{y}}_{t} - {\sum }_{{y}_{t}^{′} ∈ 𝒴} p ( {y}_{t}^{′} \vert {y}_{- t} , x ) {\underline{y}}_{t}^{′} ) + ( {\underline{y}}_{t} - {\sum }_{{y}_{t}^{′} ∈ 𝒴} p ( {y}_{t}^{′} \vert {y}_{- t} , x ) {\underline{y}}_{t}^{′} ) ⊗ {\underline{y}}_{t + 1} = {\underline{y}}_{t - 1} ⊗ {\underline{e}}_{t} + {\underline{e}}_{t} ⊗ {\underline{y}}_{t + 1} \qquad ( 21 )$$

At operation 915, the system stores the gradient of the conditional loss during training of the neural network. In some cases, the operations of this step refer to, or may be performed by, an influence component as described with reference to FIGS. 2 and 3. For example, in some cases, the neural network is trained as described with reference to FIG. 6, and the influence component stores the gradient of the conditional loss during the training of the neural network in a database (such as the database as described with reference to FIG. 1).

Referring to equation (21), the gradient with respect to W decomposes as an outer product of an error vector eₜ=(ₜ−Σ_{y′}_{ₜ}_{∈y}p(y′ₜ|y₋ₜ, x)y′ₜ) and a feature vector F(x)ₜ. In some cases, therefore, the influence component stores the feature vector and the error vector separately, thereby reducing the complexity and amount of data stored.

### Neural Network Retraining

A method for data correction is described with reference to FIG. 10. One or more aspects of the method include training a neural network to generate a plurality of labels corresponding to different parts of an input sample, respectively, wherein the neural network is trained based on a training set comprising a plurality of training samples and a plurality of training labels corresponding to parts of the plurality of training samples; identifying a false label from among the plurality of labels generated by the neural network; computing an influence of each of the plurality of training labels on the false label by approximating a change in a conditional loss for the neural network corresponding to each of the plurality of training labels; correcting a source label corresponding to a part of a training sample from the plurality of training samples based on the computed influence to obtain a corrected training set; and retraining the neural network based on the corrected training set.

Some examples of the method include selecting a validation set corresponding to the training set, wherein the validation set includes the input sample and a ground-truth label for the input sample. Some examples further include generating the false label using the neural network. Some examples further include comparing the false label to the ground-truth label, wherein the false label is identified based on the comparison.

Some examples of the method further include applying a non-zero weight to the conditional loss for the part of the training sample. Some examples further include computing a gradient of the conditional loss for the part of the training sample, wherein the change in the conditional loss is approximated based on the non-zero weight and the gradient.

Some examples of the method further include displaying the input sample and the plurality of labels in a user interface. Some examples further include receiving a user input identifying the false label from among the plurality of labels via the user interface. Some examples of the method further include displaying the part of the training sample and the corresponding source label in a user interface. Some examples further include receiving a user input identifying the part of the training sample or the corresponding source label, wherein the part of the training sample and the source label are identified based on the user input.

Some examples of the method further include receiving a corrected label via a user interface. Some examples further include replacing the source label with the corrected label, wherein the corrected training set includes the corrected label.

FIG. 10 shows an example of neural network retraining according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, according to some aspects, the system trains a neural network based on a training set including a set of training samples and a set of training labels to generate a set of labels corresponding to different parts of an input sample. The system identifies a false label among the set of labels and computes an influence of each of the training labels on the false label. The system corrects a source label corresponding to a part of a training sample from the set of training samples based on the computed influence to obtain a corrected training set and retrains the neural network based on the corrected training set.

At operation 1005, the system trains a neural network to generate a set of labels corresponding to different parts of an input sample, respectively, where the neural network is trained based on a training set including a set of training samples and a set of training labels corresponding to parts of the set of training samples. In some cases, the operations of this step refer to, or may be performed by, a training component as described with reference to FIG. 2.

For example, in some cases, the training component trains the neural network ƒ_{θ} to assign to each sample (e.g., a token) xᵢₜ∈V in an input sequence xᵢ (of length Tᵢ) a label yᵢₜ from a label set Y. In some cases, the training set is denoted by D, where [symbol] ={(xᵢ={xᵢₜ}ₜ₌₁^{T}^{ᵢ}, yᵢ={yᵢₜ}ₜ₌₁^{T}^{ᵢ})}.

In some cases, the neural network ƒ_{θ} is a model that yields conditional probability estimates for sequence label assignments: p_{θ}(yᵢ|xᵢ). For example, given parameter estimates \hat{θ}, the neural network can make a prediction for a test instance xᵢ by selecting the most likely y:ŷᵢ=argmaxᵤ p_{\hat{θ}}(y|xᵢ). In some cases, such as structured prediction tasks, the label yᵢₜ is based in part on labels yᵢ\yᵢₜ, given the input xᵢ. In some cases, such as linear chain sequence tagging, the association of the label yᵢₜ with the labels yᵢ\yᵢₜ given the input xᵢ is formalized as a graphical model in which adjacent labels are connected.

According to some aspects, parameters θ of the neural network ƒ_{θ} are typically estimated by minimizing the negative log-likelihood loss of the training dataset D:

$${argmin}_{θ} \frac{1}{\vert 𝒟 \vert} {\sum }_{( {x}_{i} , {y}_{i} ) ∈ 𝒟} - log {p}_{θ} ( {y}_{i} \vert {x}_{i} ) \qquad ( 22 )$$

In some case, the loss (e.g., the negative log likelihood) of an example zᵢ=(xᵢ, yᵢ) is expressed as [symbol] (zᵢ, θ)=−log p_{θ}(yᵢ|xᵢ), and the overall loss over the training set is expressed by

$$ℒ ( 𝒟 , θ ) = \frac{1}{\vert 𝒟 \vert} {\sum }_{{z}_{i} ∈ 𝒟} ℒ ( {z}_{i} , θ ) .$$

At operation 1010, the system identifies a false label from among the set of labels generated by the neural network. In some cases, the operations of this step refer to, or may be performed by, an influence component as described with reference to FIGS. 2 and 3. For example, in some cases, the influence component identifies the false label as described with reference to FIGS. 6 and 8.

At operation 1015, the system computes an influence of each of the set of training labels on the false label by approximating a change in a conditional loss for the neural network corresponding to each of the set of training labels. In some cases, the operations of this step refer to, or may be performed by, an influence component as described with reference to FIGS. 2 and 3. For example, in some cases, the influence component computed the influence each of the set of training labels on the false label as described with reference to FIGS. 6 and 9.

At operation 1020, the system corrects a source label corresponding to a part of a training sample from the set of training samples based on the computed influence to obtain a corrected training set. In some cases, the operations of this step refer to, or may be performed by, a modification component as described with reference to FIGS. 2 and 3.

According to some aspects, the modification component identifies a part of a training sample of the plurality of training samples and a corresponding source label from among the plurality of training labels based on the computed influence as described with reference to FIG. 6.

In some cases, the modification component receives a corrected label via a user interface and replaces the source label with the corrected label such that the corrected training set includes the corrected label. For example, referring to FIG. 4, the user interface includes a correction element associated with the false label that allows a user to provide a corrected label to the modification component in response to a user input provided to the correction element. In some cases, the modification component replaces the false label with the corrected label in the training set in response to receiving the corrected label in order to obtain the corrected training set. In some cases, the modification component stores the corrected training set in a database, such as the database as described with reference to FIG. 1.

At operation 1025, the system retrains the neural network based on the corrected training set. In some cases, the operations of this step refer to, or may be performed by, a training component as described with reference to FIG. 2.

For example, in some cases, the training component retrieves the corrected training set from the modification component and/or the database and trains the neural network using the corrected training set. In some cases, the corrected training set comprises a plurality of training samples and a plurality of training labels corresponding to parts of the plurality of training samples, including the corrected source label and a corresponding training sample, and the training component trains the neural network by minimizing an overall loss over the corrected training set

$$ℒ ( 𝒟 , θ ) = \frac{1}{\vert 𝒟 \vert} {\sum }_{{z}_{i} ∈ 𝒟} ℒ ( {z}_{i} , θ ) .$$

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data correction, comprising:
identifying a false label from among a plurality of predicted labels corresponding to different parts of an input sample, wherein the plurality of predicted labels is generated by a neural network trained based on a training set comprising a plurality of training samples and a plurality of training labels corresponding to parts of the plurality of training samples;
computing an influence of each of the plurality of training labels on the false label by approximating a change in a conditional loss for the neural network corresponding to each of the plurality of training labels;
identifying a part of a training sample of the plurality of training samples and a corresponding source label from among the plurality of training labels based on the computed influence; and
modifying the training set based on the identified part of the training sample and the corresponding source label to obtain a corrected training set.

2. The method of claim 1, further comprising:
displaying the input sample and the plurality of predicted labels in a user interface; and
receiving a user input identifying the false label from among the plurality of predicted labels via the user interface.

3. The method of claim 1, further comprising:
displaying the part of the training sample and the corresponding source label in a user interface; and
receiving a user input identifying the part of the training sample or the corresponding source label, wherein the part of the training sample and the corresponding source label are identified based on the user input.

4. The method of claim 1, further comprising:
receiving a corrected label via a user interface; and
replacing the corresponding source label with the corrected label, wherein the corrected training set includes the corrected label.

5. The method of claim 1, further comprising:
selecting a validation set corresponding to the training set, wherein the validation set includes the input sample and a ground-truth label for the input sample;
generating the false label using the neural network; and
comparing the false label to the ground-truth label, wherein the false label is identified based on the comparison.

6. The method of claim 1, further comprising:
applying a non-zero weight to the conditional loss for the part of the training sample; and
computing a gradient of the conditional loss for the part of the training sample, wherein the change in the conditional loss is approximated based on the non-zero weight and the gradient.

7. The method of claim 6, further comprising:
storing the gradient of the conditional loss during training of the neural network.

8. The method of claim 1, further comprising:
identifying a plurality of encoder output weights and a plurality of class transition parameters, wherein the influence is approximated based on the plurality of encoder output weights and is independent of the class transition parameters.

9. The method of claim 1, wherein:
the input sample comprises a text sample and the false label corresponds to a phrase of the text sample.

10. The method of claim 1, further comprising:
retraining the neural network based on the corrected training set.

11. A method for data correction, comprising:
training a neural network to generate a plurality of labels corresponding to different parts of an input sample, respectively, wherein the neural network is trained based on a training set comprising a plurality of training samples and a plurality of training labels corresponding to parts of the plurality of training samples;
identifying a false label from among the plurality of labels generated by the neural network;
computing an influence of each of the plurality of training labels on the false label by approximating a change in a conditional loss for the neural network corresponding to each of the plurality of training labels;
correcting a source label corresponding to a part of a training sample from the plurality of training samples based on the computed influence to obtain a corrected training set; and
retraining the neural network based on the corrected training set.

12. The method of claim 11, further comprising:
selecting a validation set corresponding to the training set, wherein the validation set includes the input sample and a ground-truth label for the input sample;
generating the false label using the neural network; and
comparing the false label to the ground-truth label, wherein the false label is identified based on the comparison.

13. The method of claim 11, further comprising:
applying a non-zero weight to the conditional loss for the part of the training sample; and
computing a gradient of the conditional loss for the part of the training sample, wherein the change in the conditional loss is approximated based on the non-zero weight and the gradient.

14. The method of claim 11, further comprising:
displaying the input sample and the plurality of labels in a user interface; and
receiving a user input identifying the false label from among the plurality of labels via the user interface.

15. The method of claim 11, further comprising:
displaying the part of the training sample and the corresponding source label in a user interface; and
receiving a user input identifying the part of the training sample or the corresponding source label, wherein the part of the training sample and the corresponding source label are identified based on the user input.

16. The method of claim 11, further comprising:
receiving a corrected label via a user interface; and
replacing the source label with the corrected label, wherein the corrected training set includes the corrected label.

17. An apparatus for data correction, comprising:
a processor;
a memory including instructions executable by the processor;
a neural network trained to generate labels corresponding to different parts of an input; and
an influence component configured to compute an influence of each of a plurality of training labels on a target label by approximating a change in a conditional loss for the neural network corresponding to each of the plurality of training labels.

18. The apparatus of claim 17, further comprising:
a modification component configured to identify the target label or a part of the input corresponding to the target label and to correct a training label of the plurality of training labels that influence the target label.

19. The apparatus of claim 18, further comprising:
a user interface, wherein the modification component is further configured to receive the input identifying the target label or the part of the input corresponding to the target label via the user interface and to receive the input correcting the training label of the plurality of training labels that influence the target label via the user interface.

20. The apparatus of claim 17, further comprising:
a user interface, wherein the influence component is further configured to display the labels corresponding to the different parts of the input via the user interface.
